(19) United States
(12) Patent Application Publication
(10) Pub. No.: US 2025/0256317 A1
(43) Pub. Date: Aug. 14, 2025

(54) METHOD FOR MANUFACTURING SEAMLESS CAN

(71) Applicant: TOYO SEIKAN CO., LTD., Tokyo (JP)

(72) Inventors: Yuki UEHARA, Yokohama-shi (JP); Hayato FUKUMOTO, Yokohama-shi (JP)

(73) Assignee: TOYO SEIKAN CO., LTD., Tokyo (JP)

(21) Appl. No.: 19/191,232

(22) Filed: Apr. 28, 2025

Related U.S. Application Data
(63) Continuation of application No. PCT/JP2023/037626, filed on Oct. 18, 2023.

(30) Foreign Application Priority Data
Nov. 15, 2022 (JP) 2022-182704

(51) Int. Cl. B21D 22/28; B21D 51/26

(52) U.S. Cl. CPC B21D 22/28; B21D 51/26

(57) ABSTRACT

Provided is a method for manufacturing a seamless can, which includes: molding a preform can formed with a dome portion formed at the center of a bottom portion and protruding inside the preform can and a leg portion including a grounding portion having an annular shape and formed surrounding the dome portion; performing first bottom coating of performing an outer surface coating on at least the grounding portion; performing bottom reformation of forming a curved end having an annular shape and including a grounding portion by inserting a pressing body into the preform can coated in the first bottom coating and pressing the bottom portion of the preform can by the pressing body and a molding die installed on an outer surface side of the preform can; and performing a second bottom coating of performing an outer surface coating on at least the grounding portion of the curved end.

### CROSS-REFERENCE TO RELATED APPLICATIONS

This application is a Rule 53(b) Continuation of International Application No. PCT/JP2023/037626 filed on Oct. 18, 2023, claiming priority based on Japanese Patent Application No. 2022-182704 filed on Nov. 15, 2022, the respective disclosures of which are incorporated herein by reference in their entirety.

### TECHNICAL FIELD

The disclosure relates to a method for manufacturing a seamless can, more specifically, to a method for manufacturing a seamless can in which a bottom coat can be reliably applied to a grounding portion of a seamless can subjected to a bottom reforming process, and to a seamless can to which a bottom coat is reliably applied and which is subjected to a bottom reforming process.

### BACKGROUND

As a can body for storing beverages and food, a seamless can (DI can) that is formed by a drawing and ironing process, or the like, is widely used. In such a seamless can, thinning of a can body portion is required for resource saving and weight reduction. On the other hand, it is necessary to have a sufficient compressive strength even in a thinned can body. Thus, in order to secure the compressive strength, doming formation of forming a bottom portion of the can into a shape including a dome portion recessed inwardly of the can body and an annular leg portion surrounding the dome portion is widely performed (for example, see JP 3603975 B).

In the molding process of a seamless can, coating a grounding portion of the can body with a transparent paint (bottom coat) has been performed in the related art in order to improve the conveyability of the can body to each process and to reduce the friction of the grounding portion of the can body during conveyance (for example, see JP H04-267733 A).

In such a seamless can, various proposals have been made for the shape of the bottom portion in order to provide a higher compressive strength to a thin can body.

For example, in JP 2022-46224 A, a method for manufacturing a can body is provided. The method includes molding a preform can by molding, in a bottom portion of a bottomed cylindrical body, a dome portion recessed inwardly of the bottomed cylindrical body and a leg portion having an annular shape and protruding to a side opposite to a side where the dome portion is recessed, an inner peripheral portion of the leg portion inclining in an axis direction of the can with a ground point of the leg portion as a base point in a longitudinal cross-sectional view along the axis direction of the can, painting at least one of an inner surface and an outer surface of the preform can, and performing a bottom reformation of molding a molded can including a curved end around the dome portion by pressing an inner surface of the dome portion in the preform can painted in the painting.

According to the manufacturing method, it is possible to manufacture a preform can in which a coating film is accurately applied to the inner and outer surfaces of the curved end of the bottom portion. In addition, it is possible to cause an inner periphery of the curved end to recess deeply in a direction of the body portion compared with a case of bottom reformation using a roller in the related art. Thus, it is possible to mold a can body with higher compressive strength.

### SUMMARY

In the manufacturing method described in JP 2022-46224 A, it is also necessary to perform bottom coating on the grounding portion of the bottom portion of the preform can at a stage prior to the bottom reformation, as described above.

However, in JP 2022-46224 A, in the bottom reformation, the grounding portion of the preform can is formed conforming with the molding die by a pressing body inserted into the preform can and abutting against the inner surface of the dome portion and the molding die positioned on an outer surface side of the bottom portion of the preform can. As a result, a portion that was the grounding portion in the preform can becomes an outer peripheral wall of the bottom portion. As a result, in the can body after the bottom reformation, a part of the portion that was an inner peripheral wall of the annular leg portion in the preform can becomes a new grounding portion, which results in a state where the bottom coating is not applied to the grounding portion, making it difficult to ensure the conveyability of the can body.

It is also conceivable to apply the bottom coating to a portion that becomes the grounding portion after the bottom reformation in the preform can in advance, but the coating on the inner peripheral wall of the annular leg portion requires spray coating or the like. Since the angle and position adjustment is complicated, it is difficult to employ the method in terms of productivity.

Thus, an object of the disclosure is to provide, in a method for manufacturing a seamless can in which bottom reformation is performed by the pressing body inserted into the preform can and abutting against the inner surface of the dome portion and the molding die positioned on the outer surface side of the preform can, a method for manufacturing a can body in which a bottom-coating film is reliably applied to the grounding portion of the bottom portion, and a can body formed by this manufacturing method.

According to the disclosure, a method for manufacturing a seamless can including a bottom portion and a body portion is provided. The method includes molding a preform can formed with a dome portion protruding inside the preform can at the center of the bottom portion and a leg portion including an inner peripheral wall extending downward in an axial direction of the preform can from an outer peripheral edge of the dome portion, an outer peripheral wall having a tapered shape, extending downward in the axial direction of the preform can from a lower end of the body portion, and having an outer diameter decreasing as the outer peripheral wall extends downward, and a grounding portion having an annular shape, located at a lower end of the inner peripheral wall and a lower end of the outer peripheral wall and formed surrounding the dome portion, performing a first bottom coating of performing an outer surface coating on at least the grounding portion of the preform can, performing a bottom reformation of bending the inner peripheral wall inward in a radial direction of the preform can to form a curved end including a grounding portion and having an annular shape by inserting a pressing body into the preform can coated in the first bottom coating and pressing the bottom portion of the preform can by the pressing body and a molding die installed on an outer surface side of the preform can, and performing a second bottom coating of performing an outer surface coating on at least the grounding portion of the curved end formed in the bottom reformation.

In the method for manufacturing a seamless can according to the disclosure, preferably
(1) the coating in the second bottom coating is coating by using an ultraviolet curable coating material,
(2) the method includes performing printing and inner surface coating between the first bottom coating and the bottom reformation,
(3) the method includes neck processing and flange processing after the second bottom coating, and
(4) the method includes neck processing and flange processing before the second bottom coating.

According to the disclosure, a seamless can including a bottom portion and a body portion is provided. The seamless can is formed with, in the bottom portion, a dome portion protruding inside the seamless can at the center of the bottom portion and a leg portion having an annular shape and including an inner peripheral wall having a tapered shape, extending downward in an axial direction of the seamless can from an outer peripheral edge of the dome portion and having an inner diameter decreasing as the inner peripheral wall extends downward, an outer peripheral wall having a tapered shape, extending downward in the axial direction of the seamless can from a lower end of the body portion and having an outer diameter decreasing as the outer peripheral wall extend downward, and a curved end having an annular shape, formed by lower portions of the inner peripheral wall and the outer peripheral wall, and including a grounding portion, and a coating film made of ultraviolet curable coating material is formed near the curved end of the outer peripheral wall and at the grounding portion of the curved end.

The seamless can according to the disclosure is preferably a seamless can made of aluminum.

In addition, according to the disclosure, a content filled can formed by seaming and sealing the seamless can filled with the contents with a lid is provided.

In the manufacturing method of the seamless can according to the disclosure, the bottom reformation using the pressing body inserted in the preform can and the molding die located on the outer surface side of the preform can is performed. Thus, even when a portion where the bottom coat is not applied becomes the grounding portion, the grounding portion of the can bottom is always effectively protected by the bottom-coating film because there is the second bottom coating after the bottom reformation, and when the can body is conveyed after the bottom reformation, friction of the can body can be reduced and conveyability can be improved.

In addition, in the bottom coating, positional adjustment for performing spray coating is not required, and the bottom-coating film can be easily and reliably formed at the grounding portion of the bottom portion, so that productivity is also excellent.

In the seamless can of the disclosure, because the bottom reformation is performed by an apparatus including the above-mentioned specific pressing body and the molding die, the inner periphery of the curved end at the bottom portion of the seamless can is deeply recessed in the direction of the body portion, and the compressive strength can be remarkably increased.

### BRIEF DESCRIPTION OF DRAWINGS

FIG. 1 is a vertical cross-sectional view illustrating an example of a preform can in a manufacturing method according to the disclosure.

FIGS. 2(A), 2(B), and 2(C) are diagrams for describing a bottom reforming process of a manufacturing method according to the disclosure.

FIG. 3 is a partially enlarged cross-sectional view illustrating a seamless can according to the disclosure.

### DESCRIPTION OF EMBODIMENTS

### Manufacturing Process

A manufacturing process for a seamless can generally includes a cupping process, a preform can molding process, a trimming process, a cleaning process, a first bottom-coating process, an outer surface coating and printing process, a printing process, an inner surface coating process, a bottom reforming process, and a neck and flange processing process, and a second bottom-coating process is further included. The disclosure has an important feature in that a second bottom-coating process is added after the bottom reforming process.

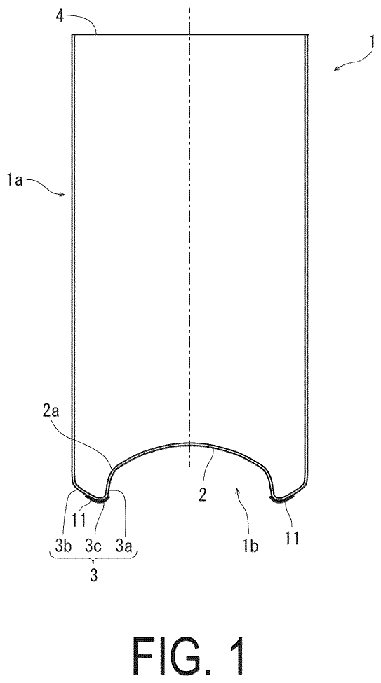

In the cupping process, a metal plate such as an aluminum alloy plate is drawn to mold a cup-shaped body, and then, in a preform can forming process, the cup-shaped body is drawn and ironed to mold a bottomed cylindrical body, and the bottom portion is pressed to mold a preform can. The preform can includes a body portion la and a bottom portion 1b as illustrated in FIG. 1. A dome portion 2 protruding inside the can is formed at the center of the bottom portion 1b, and a leg portion 3 having an annular shape is formed so as to surround the dome portion 2. The leg portion 3 illustrated in FIG. 1 includes an inner peripheral wall 3a extending downward in the axial direction of the can from an outer peripheral edge 2a of the dome portion 2, an outer peripheral wall 3b having a tapered shape, extending downward in the axial direction of the can from the lower end of the body portion la and having an outer diameter decreasing as the outer peripheral wall 3b extends downward, and a grounding portion 3c located at a lower end of the inner peripheral wall 3a and a lower end of the outer peripheral wall 3b.

After an opening end 4 of the obtained preform can 1 is trimmed (trimming process) and subjected to a cleaning process, in a first bottom-coating process, a bottom-coating film 11 made of a transparent coating material capable of reducing friction and improving conveyability is formed near the grounding portion of the bottom portion of the preform can, and then the resultant is subjected to an outer surface coating and printing process.

In the outer surface coating and printing process, the outer surfaces of the body portion and the bottom portion of the preform can are coated to form an outer surface coating film, and in the printing process, printing is performed on the outer surface coated body portion, and a finishing varnish layer is formed on the printing layer as necessary. Note that when the outer surface coating film formation is not required by using a resin-coated metal plate or the like as described below, the outer surface coating process may be omitted. As long as it is possible to apply a transparent coating material suitable for a bottom coat near the grounding portion of the bottom portion, the first bottom-coating process may be performed in the same process as the outer surface coating process. Subsequently, in the inner surface coating process, an inner surface coating film is formed on the inner surface of the preform can by spray coating or the like.

After the inner surface coating process, the preform can 1 is then subjected to the bottom reforming process to be molded into a seamless can 10 having the bottom shape of a bottom-reformed final molded product.

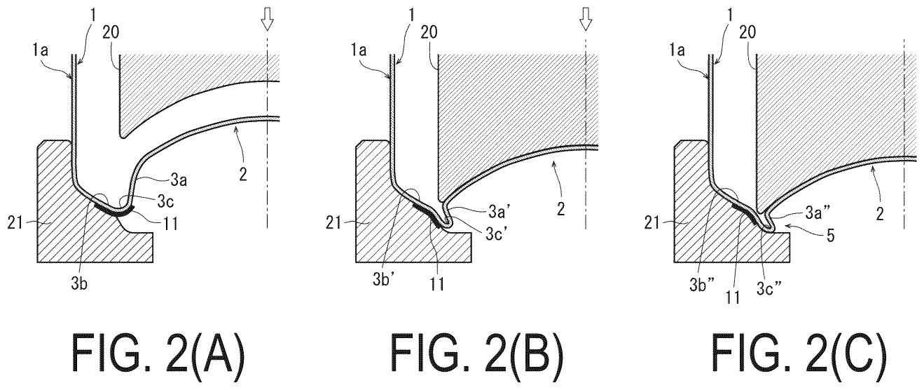

FIGS. 2(A), 2(B), and 2(C) are diagrams for describing the bottom reforming process, and the preform can 1, in which the bottom-coating film 11 is formed near the grounding portion of the bottom portion, is placed on the molding die 21 with which the lower portion of the body portion la on the outer surface side and the outer peripheral wall 3b of the bottom portion of the preform can 1 come into contact. Then, a pressing body 20 is inserted inside the preform can 1 (FIG. 2(A)).

When the inner surface of the preform can 1 is pressed by the pressing body 20, the inner peripheral wall 3a of the preform can 1 is pushed in the axial direction of the can and curved inward in a radial direction of the can to form a shape like 3a′ in FIG. 2(B), while an outer peripheral wall 3b′ conforming with the molding surface of the molding die 21 is formed from the grounding portion 3c (FIG. 2(B)).

When the movement of the pressing body 20 is completed, the shape of the annular leg portion is formed as a curved end 5 having an annular shape in which the inner peripheral wall 3a is curved inward in the radial direction of the can. The lowest end of the curved end 5 becomes the grounding portion 3c″, which has a bottom shape of the bottom-reformed final molded product.

As is clear from FIGS. 2(A), 2(B), and 2(C), since the bottom-coating film 11 formed at the grounding portion 3c of the preform can 1 becomes the outer peripheral wall 3b″ of a can body 10 after the bottom reforming in the bottom reforming process, no bottom-coating film is formed in the grounding portion 3c″ of the can body 10 after the bottom reforming.

In the manufacturing method according to the disclosure, from such a viewpoint, a second bottom coating process is provided after the bottom reforming process, and a transparent coating material is applied near the grounding portion of the can body after the bottom reforming process to reduce friction associated with transportation and to improve conveyability in the same manner as in the first bottom-coating process.

Note that in the first and second bottom-coating processes, all of the coating materials, coating methods, baking methods, or the like in the related art used for bottom coat can be adopted. However, in the manufacturing method of the disclosure, especially, in the second bottom coating process, it is preferable to employ a roll coating method and use an ultraviolet curable coating material to form a bottom-coating film by ultraviolet irradiation. An oven for baking is not required after the bottom coating process by using an ultraviolet curable coating material, so that the manufacturing line can be simplified. The coating method is not limited to the roll coating method, and any known method can be applied.

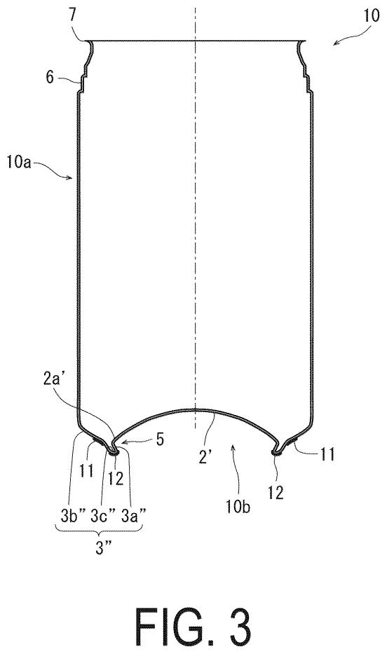

The seamless can 10, in which a bottom-coating film 12 is formed in the grounding portion 3c″ by the second bottom-coating process, is then subjected to the neck and flange processing process, and neck-in processing and flange processing are performed to obtain the seamless can 10, which is a final molded product having a neck portion 6 with a reduced diameter and a flange portion 7, as illustrated in FIG. 3.

In the manufacturing method of the disclosure, the second bottom-coating process may be performed after the bottom reforming process, and is not limited to the case where the second bottom coating process is performed between the bottom reforming process and the neck and flange processing process as described above. That is, in some cases, the neck and flange processing is performed before the bottom reforming process, and in such cases, the second bottom-coating process is performed after the neck and flange processing process and the bottom reforming process. Furthermore, in the case where the neck and flange processing process is performed immediately after the bottom reforming process, the second bottom-coating process is also performed after the neck and flange processing process.

In the manufacturing method according to the disclosure, the molding of the preform can is not limited to the method described above, and a known method such as drawing, drawing and deep drawing, drawing and ironing, drawing and stretch bending, and ironing can be employed.

In addition, the shape of the seamless can is not limited to the seamless can having a shape illustrated in FIG. 3 as long as a shape of the bottom portion is the shape described above, and various shapes of the seamless can, such as a so-called bottle can in which a neck portion is greatly reduced in diameter and a screw portion is provided, can be manufactured.

Furthermore, as the metal plate constituting the seamless can, all metal plates used in the related art for the seamless can, such as a surface-treated steel plate and an aluminum alloy plate, can be used, but the aluminum alloy plate is particularly preferable. These metal plates may be resin-coated metal plates coated with a thermoplastic resin such as polyester resin. When such a resin-coated metal plate is used, the above-described outer surface coating process and inner surface coating process can be omitted if necessary.

### Seamless Can

As illustrated in FIG. 3, the seamless can manufactured by the manufacturing method of the disclosure, based on the characteristics of the manufacturing method described above, is formed with, at the bottom portion 10b, a dome portion 2′ protruding inside the can at the center of the bottom portion and a leg portion 3″. The leg portion 3″ includes an inner peripheral wall 3a″ having a tapered shape, extending downward in the axial direction of the can from the outer peripheral edge 2a′ of the dome portion 2′ and having an inner diameter decreasing as the inner peripheral wall 3a″ extends downward, an outer peripheral wall 3b″ having a tapered shape, extending downward in the axial direction of the can from the lower end of a body portion 10a and having an outer diameter decreasing as the outer peripheral wall 3b″ extends downward, and a curved end 5 having an annular shape, formed by lower portions of the inner peripheral wall 3a″ and the outer peripheral wall 3b″, and including a grounding portion 3c″. A coating film 12 formed by the second bottom-coating process is formed at and near the grounding portion 3c″. The bottom-coating film 12 is preferably a coating film made of an ultraviolet curable coating material.

In the seamless can of the disclosure, as described above, the inner periphery 3a″ of the curved end 5 at the bottom portion of the seamless can is deeply recessed outward in the radial direction of the can, so that the deformation of the dome portion due to the change of internal pressure is easy, which results in high compressive strength.

In the seamless can of the disclosure, the seamless can having the opening shape as illustrated in FIG. 3 is provided to the consumer as a content filled can formed by filling the seamless can with the contents and then seaming and sealing the seamless can with the can lid. As the can lid used for such a content filled can, a known shape in the related art such as an easy open lid provided with a score for forming an opening for pouring the contents and a tab for opening may be adopted, and either a full open type or a partial open type (stay on tab type) may be used.

The content filled can can be filled with, in addition to beverages such as soft drinks and carbonated beverages, known contents in the related art such as foodstuffs. However, the content filled can preferably can be filled with beverages having natural pressure such as beer and carbonated beverages because the bottom shape is particularly excellent in pressure resistance.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims

1. A method for manufacturing a seamless can including a bottom portion and a body portion, the method comprising:
molding a preform can formed with a dome portion protruding inside the preform can at the center of the bottom portion and a leg portion including an inner peripheral wall extending downward in an axial direction of the preform can from an outer peripheral edge of the dome portion, an outer peripheral wall having a tapered shape, extending downward in the axial direction of the preform can from a lower end of the body portion, and having an outer diameter decreasing as the outer peripheral wall extends downward, and a grounding portion having an annular shape, located at a lower end of the inner peripheral wall and a lower end of the outer peripheral wall, and formed surrounding the dome portion;
performing first bottom coating of performing an outer surface coating on at least the grounding portion of the preform can;
performing bottom reformation of bending the inner peripheral wall inward in a radial direction of the preform can to form a curved end having an annular shape and including a grounding portion by inserting a pressing body into the preform can coated in the first bottom coating, and pressing the bottom portion of the preform can by the pressing body and a molding die installed on an outer surface side of the preform can; and
performing a second bottom coating of performing an outer surface coating on at least the grounding portion of the curved end formed in the bottom reformation.

2. The method for manufacturing a seamless can according to claim 1, wherein
the coating in the second bottom coating is coating by using an ultraviolet curable coating material.

3. The method for manufacturing a seamless can according to claim 1, further comprising:
performing printing and inner surface coating between the first bottom coating and the bottom reformation.

4. The method for manufacturing a seamless can according to claim 1, further comprising
performing neck processing and flange processing after the second bottom coating.

5. The method for manufacturing a seamless can according to claim 1, further comprising
performing neck processing and flange processing before the second bottom coating.

6. A seamless can, comprising:
a bottom portion; and
a body portion,
wherein the bottom portion is formed with a dome portion protruding inside the seamless can at the center of the bottom portion, and a leg portion having an annular shape and including an inner peripheral wall having a tapered shape, extending downward in an axial direction of the seamless can from an outer peripheral edge of the dome portion and having an inner diameter decreasing as the inner peripheral wall extends downward, an outer peripheral wall having a tapered shape, extending downward in the axial direction of the seamless can from an lower end of the body portion and having an outer diameter decreasing as the outer peripheral wall extends downward, and a curved end having an annular shape, formed by lower portions of the inner peripheral wall and the outer peripheral wall, and
a coating film made of ultraviolet curable coating material is formed near the curved end of the outer peripheral wall and at the grounding portion of the curved end.

7. The seamless can according to claim 6, wherein
the seamless can is a seamless can made of aluminum.

8. A content filled can formed by seaming and sealing, with a lid, the seamless can according to claim 6 filled with the contents.
